(19) United States
(12) Patent Application Publication
(10) Pub. No.: US 2022/0179524 A1
(43) Pub. Date: Jun. 9, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Ryo KANAYA, Yokohama-shi (JP)

(73) Assignee: FUJIFILM Business Innovation Corp., Tokyo (JP)

(21) Appl. No.: 17/322,550

(22) Filed: May 17, 2021

(30) Foreign Application Priority Data
Dec. 3, 2020 (JP) 2020-201326

(51) Int. Cl. G06F 3/0482; G06F 3/0485

(52) U.S. Cl. CPC G06F 3/0482; G06F 3/0485

(57) ABSTRACT

An information processing apparatus includes a processor configured to: display on a screen a form image serving as a target that a form type is to be set to, multiple registration images, each registration image pre-registered on a per form type basis, and a setting control used to set a form type to the form image; and set on the form image a form type that a user having referenced the registration images associates the setting control with.

### CROSS-REFERENCE TO RELATED APPLICATIONS

This application is based on and claims priority under 35 USC 119 from Japanese Patent Application No. 2020-201326 filed Dec. 3, 2020.

### BACKGROUND

### (i) Technical Field

The present disclosure relates to an information processing apparatus and a non-transitory computer readable medium.

### (ii) Related Art

Japanese Unexamined Patent Application Publication No. 2002-334333 discloses an information processing apparatus that performs format setting of a read document image and sorts documents according to a document format. The information processing apparatus includes a determination unit, memory, and user interface unit. The determination unit determines the format of a document image as a format determination target in accordance with a similarity between a document format as a format determination target and a registered document format. The memory stores determination information in association with a format-determined document image. The determination information is used to determine whether determination results of the determination unit is to be confirmed by a user. The user interface unit prompts the user to confirm or correct the sorting by displaying a document image that has been determined as to be confirmed by the user in accordance with the determination information stored on the memory.

If a document itself is stored, information thereon is not smoothly accessible. An information processing apparatus is thus available in related art. The information processing apparatus performs an optical character recognition (OCR) operation on image data of a document to digitize the information on the document and processes resulting digital information.

The image data of the document may be image data of a form, in other words, the image data may be a form image. The information processing apparatus compares the form image with multiple pre-registered form images on a per type basis to determine the type of the form image.

In such a case, the information processing apparatus may be unable to determine the type of a form image because of an unknown type or may determine a form image as having an erroneous type. A user may thus correct determination results about the type of the form image provided by the information processing apparatus by referencing a registered image.

In the related-art correction operation to a form image, the user may display successively multiple registered images one by one on a screen starting with a registered image having a higher similarity with the form image and sets the type of the form image by comparing the form image with a displayed registered image. The user thus switches the screens displaying the registered images until a registered image determined to be of the same type as the form image is displayed on the screen.

### SUMMARY

Aspects of non-limiting embodiments of the present disclosure relate to providing an information processing apparatus and non-transitory computer readable medium reducing an amount of operation of a user in setting the type of a form image in comparison with when a type is set on an image form by switching the screens and referencing multiple registered images on a screen.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: display on a screen a form image serving as a target that a form type is to be set to, multiple registration images, each registration image pre-registered on a per form type basis, and a setting control used to set a form type to the form image; and set on the form image a form type that a user having referenced the registration images associates the setting control with.

### BRIEF DESCRIPTION OF THE DRAWINGS

Exemplary embodiment of the present disclosure will be described in detail based on the following figures, wherein:

FIG. 1 illustrates a configuration of a form system;

FIG. 2 illustrates an example of a confirmation correction screen;

FIG. 3 illustrates an electrical configuration of a computer forming an information processing apparatus;

FIG. 4 is a flowchart illustrating a type setting process performed by the information processing apparatus;

FIG. 5 illustrates an example of a setting screen;

FIG. 6 illustrates a display example of a set button;

FIG. 7 illustrates an example of the confirmation correction screen on which a type of each form image is set; and

FIG. 8 illustrates an example of the confirmation correction screen on which form images are sorted into record.

### DETAILED DESCRIPTION

Exemplary embodiment is described with reference to the drawings. Like elements and operations are designated with like reference numerals throughout the drawings and the discussion thereof is not duplicated.

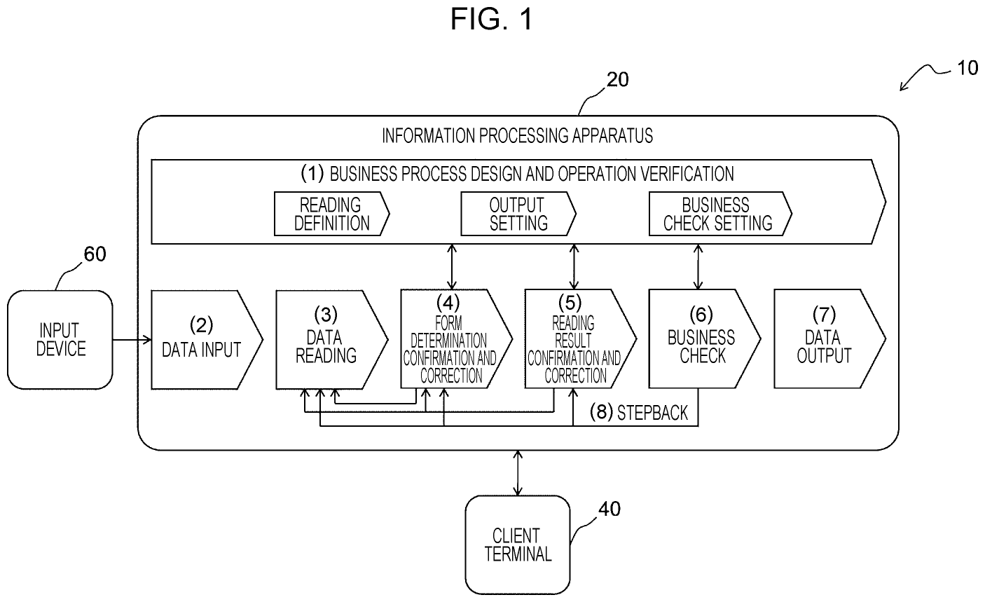

FIG. 1 illustrates the configuration of a form system 10 of the exemplary embodiment.

Referring to FIG. 1, the form system 10 includes an information processing apparatus 20, client terminal 40, and input device 60. These devices are communicably interconnected to each other via a communication network (not illustrated). The communication network may include the Internet, local-area network (LAN), and/or wide-area network (WAN).

The information processing apparatus 20 controls a series of operations including performing an OCR (optical character recognition) process on image data of a document including multiple forms input via the input device 60 and outputting the results of the OCR process to a predetermined output destination. Specific configuration and operations of the information processing apparatus 20 are described below.

The client terminal 40 transmits to the information processing apparatus 20 a variety of instructions related to the OCR process. The instructions include an instruction to start reading information on the image data and an instruction to display read results of the information on the image data. The client terminal 40 also displays a variety of information including the results of the OCR process that the information processing apparatus 20 has performed in response to the variety of instructions received, and a notification related to the OCR process. For example, the client terminal 40 may be a general-purpose computer, such as a server computer or a personal computer (PC). Although a single client terminal 40 is illustrated in FIG. 1, multiple client terminals 40 may also be used properly such that different client terminals 40 operate for different purposes.

The input device 60 inputs to the information processing apparatus 20 the image data serving as a target of the OCR process. The input device 60 may be a general-purpose computer, such as a server computer or a PC, or an image forming apparatus having a scan function, printer function, and fax function. Not only the input device 60 but also the client terminal 40 may input the image data to the information processing apparatus 20.

The configuration of the form system 10 is described below.

In the form system 10, the information processing apparatus 20 performs the OCR process on the image data input via the input device 60 and outputs the results of the OCR process to a predetermined output destination.

In the OCR process, the information processing apparatus 20 controls a variety of operations including a business process design and operation verification operation (1), data input operation (2), data reading operation (3), form determination confirmation and correction operation (4), reading result confirmation and correction operation (5), business check operation (6), data output operation (7), and step-back operation (8). According to the exemplary embodiment, the OCR process includes not only a reading operation to read characters and symbols from the image data but also a post-operation, such as a correction operation to characters.

The information processing apparatus 20 automatically performs the business process design and operation verification operation (1), data input operation (2), data reading operation (3), business check operation (6), and data output operation (7) as examples of each control operation. The form determination confirmation and correction operation (4) and reading result confirmation and correction operation (5) are received as an example of control operations when the user inputs them using the client terminal 40. The step-back operation (8) as an example of control operations may be automatically performed by the information processing apparatus 20 or accepted when the user inputs the step-back operation (8) via the client terminal 40.

In the business process design and operation verification operation (1), job rules are produced. The job rules include reading definition setting, output setting, and business check setting. For example, in the reading definition setting, a read range in which information on the image data is read is set in the data reading operation (3). Specifically, a definition of reading an item value as a value to the right of an item extracted as a key is set. For example, in the output setting, a file format and an output destination of output data to be output in the data output operation (7) are set. In the business check setting, an input item in a form serving as a detection target and a format, such as the number of inputtable characters, in the business check operation (6) are set.

In the data input operation (2), the image data is received from the input device 60. The input image data is registered as a job that serves as an execution unit in the data reading operation (3).

In the data reading operation (3), the information on the image data in the job is read by using a job rule of the job to be executed. The job rule is selected from among the job rules produced in the business process design and operation verification operation (1). For example, in the data reading operation (3), the determination of the form (hereinafter referred to as a “form determination”) is performed on the image data in the job and a character and symbol within the read range are read.

In the form determination confirmation and correction operation (4), the image data in the job is sorted into a record indicating a form in the job in accordance with results of the form determination performed in the data reading operation (3). In the form determination confirmation and correction operation (4), the sorted record is displayed and a user confirmation correction to the form determination is received.

In the reading result confirmation and correction operation (5), the results of reading the character and symbol in the read range in the data reading operation (3) are displayed and a user confirmation correction to the reading results is received.

In the business check operation (6), an error in each prior operation is detected in accordance with the business check setting included in the job rule of the job. The job rule is selected from among the job rules produced in the business process design and operation verification operation (1). The detection results may be displayed to the user.

In the data output operation (7), output data is produced using the output setting included in the job rule of the job. The job rule is selected by the user from among the job rules produced in the business process design and operation verification operation (1). The produced output data is output to a predetermined output destination.

In the step-back operation (8), processing steps back from an operation performed in the OCR process by one or more operations. For example, using the client terminal 40, the user may issue an instruction to perform the step-back operation (8) in the middle of the form determination confirmation and correction operation (4) or the reading result confirmation and correction operation (5). Typically, an instruction of the step-back operation (8) may be issued by the client terminal 40 of an administrator in response to results of an administrator check performed between the business check operation (6) and the data output operation (7).

In the OCR process, the business process design and operation verification operation (1) is performed prior to the data reading operation (3), namely, prior to the start of the operation of the form system 10. Alternatively, the business process design and operation verification operation (1) may be performed in the middle of the operation of the form system 10 that performs the data reading operation (3) or subsequent operation. For example, a job rule produced in the business process design and operation verification operation (1) prior to the operation of the form system 10 may be appropriately corrected in response to the results of the reading result confirmation and correction operation (5) with the form system 10 operating.

The image data corresponding to each form is referred to as “form image 1”. The job rule is data that defines contents of a job. The job serves as a reading unit of the form image 1 at which information is read at a time in the data reading operation (3) in FIG. 1. Since the information processing apparatus 20 handles, as a reading target, information that is read at a time from the form images 1 received from the input device 60 in the data reading operation (3) in FIG. 1, the job is a collection of the form images 1 that has been received at a time from the input device 60 as a process target of the information processing apparatus 20.

The form determination in the data reading operation (3) in FIG. 1 compares a form image 1 with sample images, each pre-registered on a per form type basis (hereinafter referred to as “registration images 3”) and determines the type of the registration image 3 more similar to the form image 1 out of the registration images 3 to be the type of the form image 1. The similarity between the form image 1 and each of the registration images 3 is calculated using related-art algorithms, including a pattern matching technique, based on a feature vector or a template, or a neural network technique. The neural network has performed machine learning that receives images as comparison targets and then outputs a similarity therebetween.

The job of the exemplary embodiment may be an aggregate of the form images 1 that is a collection of the form images 1 of the same type. Also, according to the exemplary embodiment, a collection of the form images 1 includes multiple sets of forms, each set including different types, such as form A-1 and form A-2. In other words, the job includes multiple types of form images 1. A collection of multiple types of form images included in one set is referred to as a “record.”

The form determination confirmation and correction operation (4) of the information processing apparatus 20 is described in detail.

As described above, the information processing apparatus 20 sorts the form images 1 according to record unit in accordance with the results of the form determination performed in the data reading operation (3), displays the resulting form images 1, and receives user confirmation correction to the form determination.

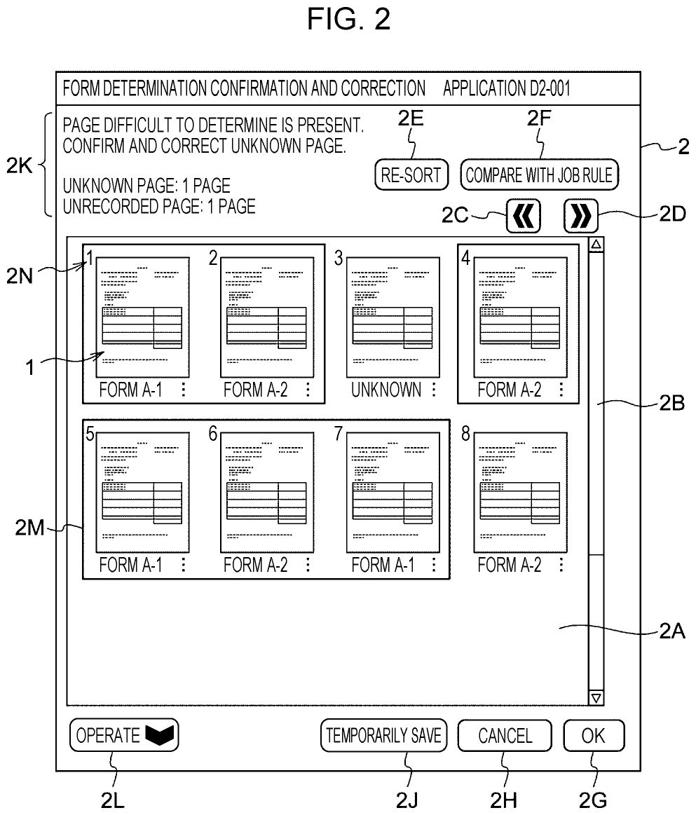

FIG. 2 illustrates an example of a confirmation correction screen 2 that receives a confirmation correction to the form determination from the user. The information processing apparatus 20 displays the confirmation correction screen 2 on the client terminal 40 of the user who has performed the OCR process.

Referring to FIG. 2, the form images 1 included in the job “application D2-001” are displayed together with the results of the form determination performed in the data reading operation (3) in FIG. 1 on a display region 2A. A page number 2N is also displayed in each form image 1 in the order of arrangement of the form images 1 in the job.

The form images 1 may include a form image 1 that is too blurred to read in terms of the location of a frame and characters in the data reading operation (3) and a form image 1 having an unknown format with a corresponding registration image 3 unregistered. In such a case, the word “unknown” is displayed as the type of the form image 1. The type of the form image 1 being unknown indicates that no type is set to the form image 1.

In order to display which form image 1 is combined with which form image 1 to form a set, the confirmation correction screen 2 displays the form images 1 enclosed within a frame 2M by a record unit. In the example of the confirmation correction screen 2 in FIG. 2, a combination of the form images 1 of form A-1 and form A-2 is a single record. If the form image 1 with an unknown type and the form images 1 of the form A-1 and the form A-2 are sequentially arranged in this order, it is difficult to sort them into records. Such form images 1 are displayed on the confirmation correction screen 2 without being record-sorted by using the frame 2M.

If all the form images 1 included in the job are difficult to display in the display region 2A, the user operates a scroll bar 2B to display the confirmation correction screen 2 remaining form images 1 that are still hidden.

The user verifies a form image 1 of unknown type and a form image 1 that is not record-sorted (hereinafter referred to as a “form image 1 to be confirmed”) from among the form images 1 displayed on the confirmation correction screen 2. To this end, the form image 1 to be confirmed may be to be detected with higher priority from among the form images 1 displayed.

However, as the number of form images 1 to be displayed on the display region 2A of the confirmation correction screen 2 increases, the user views the display region 2A while operating the scroll bar 2B and finds the form image 1 to be confirmed from among the form images 1. This operation is time-consuming with an increasing amount of operation of the scroll bar 2B. Search buttons 2C and 2D are displayed on the confirmation correction screen 2.

When the user presses the search button 2C, the information processing apparatus 20 searches the form images 1 for the form image 1 to be confirmed present prior to the form image 1 currently selected by a mouse or the like and displays on the display region 2A the form image 1 to be confirmed. The form image 1 to be confirmed is a form image 1 having a page number 2N that is smaller than the page number 2N of the currently selected form image 1 and has the smallest difference from the page number 2N of the currently selected form image 1.

When the user presses the search button 2D, the information processing apparatus 20 searches the form images 1 for the form image 1 to be confirmed present subsequent to the form image 1 currently selected by the mouse or the like and displays on the display region 2A the form image 1 to be confirmed. The form image 1 to be confirmed is a form image 1 having a page number 2N that is larger than the page number 2N of the currently selected form image 1 and has the smallest difference from the page number 2N of the currently selected form image 1.

If a single form image 1 to be confirmed is included in the job, the display of the form image 1 on the display region 2A does not change when the user presses the search button 2C or 2D with the form image 1 to be confirmed selected.

The user selection of the form image 1 includes an operation in which the user selects the form image 1 on purpose using the mouse or the like and an operation in which the user displays the form image 1 on the display region 2A by operating the scroll bar 2B. In other words, a form image 1 displayed on the display region 2A is an example of the form image 1 selected by the user.

If the user has confirmed the form image 1 of unknown type, the user sets a type to the form image 1 of unknown type by referencing the registration image 3 on a setting screen 4 described below.

Since the contents of each operation of the information processing apparatus 20 is defined in the job rule, multiple registration images 3 that the information processing apparatus 20 has referenced to determine the type of the form image 1 included in the job are defined for the form determination confirmation and correction operation (4). If the user presses a compare button 2F on the confirmation correction screen 2, the registration images 3 that the information processing apparatus 20 has referenced to determine the type of the form image 1 are displayed on the setting screen 4 described in detail below.

If the user verifies that the form image 1 has an error in the record sorting, the user performs a drag-and-drop operation on the form images 1 to modify the order of arrangement of the form images 1. This is intended to arrange the form image 1 in a correct order with the remaining form images 1 in the set. If the order of arrangement of the form image 1 is modified, the information processing apparatus 20 updates the page number 2N of the form image 1 in accordance with the new order of arrangement of the form images 1.

If the user presses a re-sort button 2E in this condition, the information processing apparatus 20 re-sorts the form image 1 in the job according to the record unit in accordance with the new order of arrangement of the form images 1 on the confirmation correction screen 2. The information processing apparatus 20 displays new sorting results on the confirmation correction screen 2 by enclosing with a frame 2M on a per record basis the form images 1 that have been re-sorted according to the record unit.

If an attempt is made to sort a form image 1 of unknown type into a record, an error may occur in the record sorting. If a correct type is set to the form image 1 of unknown type, the user presses the re-sort button 2E to re-sort the form images 1 included in the job according to the record unit.

The job may include as a determination target of the type an image of a document other than the forms pre-registered as the registration image 3. Since the type of such form image 1 is set to be unknown and unable to be sorted according to the record unit, the user may simply delete this unwanted form image 1 and presses the re-sort button 2E.

The information processing apparatus 20 displays on an information region 2K information related to confirmation correction to the form image 1 to be confirmed.

If the form image 1 of unknown type is included in the job, the information processing apparatus 20 displays information prompting the user to confirm and correct the type of the form image 1. For example, the information may be “Page difficult to determine is present. Confirm and correct unknown page.” In such a case, the information processing apparatus 20 displays on the information region 2K the number of pages of the form image 1 of unknown type in the job, for example, “Unknown page: 1 page.” Each time the user sets the type to the form image 1 of unknown type, the information processing apparatus 20 reduces the number of the form images 1 of unknown type and displays on the information region 2K the form images 1 with the reduced number of form images 1 of unknown type.

If the user thus sets the type to the form image 1 of unknown type, the information processing apparatus 20 then displays to the user on the information region 2K operation guidance notifying the user of the next operation to take. For example, the operation guidance may be a message reading “Press the re-sort button since the page of unknown type is confirmed. Forms are re-sorted according record unit.”

If the form image 1 not sorted in a record is included in the job, the information processing apparatus 20 displays on the information region 2K information prompting the user to confirm and correct the record on the form image 1. For example, the information may be a message reading “There is a page that has not been sorted according to the record unit. Take one of the following steps. (1) Re-sort after deleting the page or (2) Move the page and then re-sort.”

In this case, the information processing apparatus 20 may display on the information region 2K the number of form images 1 having an error in the record sorting in the job. For example, the information may be a message reading “Unrecorded pages: 1 page.” Each time the re-sort button 2E is pressed, the information processing apparatus 20 updates the number of form images 1 having an error in the record sorting and displays the updated number of form images 1 on the information region 2K. If the user performs a drag-and-drop operation to re-arrange the recorded form images 1, a record including the form images 1 that have been re-arranged in order is temporarily canceled. Each time the user cancels the existing record sorting, the information processing apparatus 20 increases the number of form images 1 having an error in the record sorting and displays the increased number of form images 1 on the information region 2K.

If it is confirmed that the type to each of the form images 1 included in the job is correctly set and the record sorting of the form images 1 is correctly performed, the user presses an OK button 2G to finalize the form determination and the record sorting on the form images 1 in the job. If no form image 1 of unknown type is present any longer in the job and all the form images 1 are sorted according to the record unit, the information processing apparatus 20 may display a message notifying the user of the next step to take on the information region 2K. For example, the message may read “Confirmation of the form determination is now complete. Press OK button.”

The user may press a cancel button 2H to close the confirmation correction screen 2 without finalizing the form determination and the record sorting of the form images 1 included in the job. In order to temporarily suspend and then later resume the form determination confirmation and correction operation (4), the user presses a temporarily save button 2J. The type set for the form image 1 and the state of the record sorting at the time of the pressing of the temporarily save button 2J are thus stored on a storage device.

If the user presses an operate button 2L, an operation menu related to the confirmation and correction of the form image 1 is displayed at a dropdown list. The dropdown list displays the operation menu including “reset” and “re-execute.”

The reset in the operation menu includes canceling and restoring the type set to the form image 1 and the record sorting of the form image 1 back to the statuses prior to the form determination of the information processing apparatus 20.

The re-execute in the operation menu includes selecting a job rule other than the job rule currently selected and re-executing the form determination in accordance with the newly selected job rule. The job rule to be used is specified by the user.

When the job rule is changed, the registration image 3 that the information processing apparatus 20 references to determine the type of the form image 1 included in the job is changed in response to the change of the job rule. This may lead to an increase in the accuracy level of the form determination in comparison with the accuracy level prior to the change of the job rule. For example, the reset may be performed, followed by the re-execute, and the information processing apparatus 20 may perform the form determination in accordance with another job rule. To perform this operation, the temporarily save button 2L may be used.

The information processing apparatus 20 performing the form determination includes a computer 30.

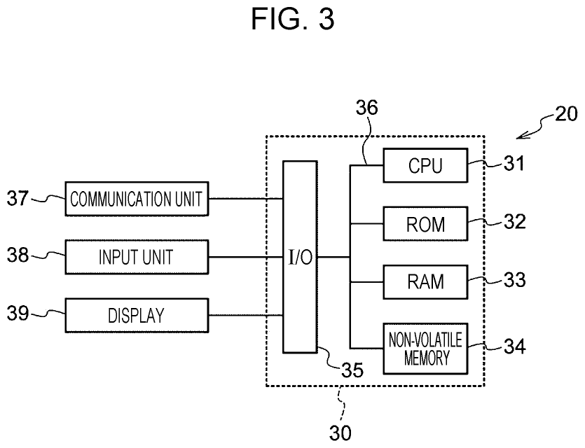

FIG. 3 illustrates an electrical configuration of the computer 30 forming the information processing apparatus 20.

The computer 30 includes a central processing unit (CPU) 31 as an example of a processor in charge of each operation in FIG. 1, read-only memory (ROM) 32 storing an information processing program causing the computer 30 to function as the information processing apparatus 20, random-access memory (RAM) 33 used as a temporary working area of the CPU 31, non-volatile memory 34, and input and output (I/O) interface 35. These elements are interconnected to each other via a bus 36.

Once the non-volatile memory 34 stores information, it continuously stores information even when power to the non-volatile memory 34 is shut off. For example, the non-volatile memory 34 may be a semiconductor memory or a hard disk. The non-volatile memory 34 stores the registration image 3 that is information that is to be continuously stored even when power to the information processing apparatus 20 is shut off.

The I/O interface 35 is connected to, for example, a communication unit 37, input unit 38, and display 39.

The communication unit 37 is connected to a communication network and supports a communication protocol. The communication protocol is used for data communication between the communication unit 37 and each of external devices, such as the input device 60 and the client terminal 40, connected to the communication network.

The input unit 38 receives an instruction from the user and notifies the CPU 31 of the received instruction. For example, the input unit 38 may include a button, touch panel, keyboard, and/or mouse.

The display 39 is an example of a device that visually displays information processed by the CPU 31. For example, the display 39 may be a liquid-crystal display or an organic electroluminescent (EL) display.

The information processing apparatus 20 may receive a user instruction from the client terminal 40 via the communication unit 37 and information processed by the information processing apparatus 20 may be displayed on the client terminal 40 via the communication unit 37. In such a case, the input unit 38 and display 39 are not used.

The non-volatile memory 34 is not necessarily built in the computer 30 but may be a portable memory removably mounted on the computer 30. Alternatively, the non-volatile memory 34 may be mounted in an external apparatus rather than in the computer 30. In such a case, the computer 30 reads information on the non-volatile memory 34 in the external apparatus via the communication unit 37 while writing information on the non-volatile memory 34 in the external apparatus via the communication unit 37.

The type setting process to set a type to the form image 1 that the information processing apparatus 20 has determined as having an unknown type in the form determination is described below.

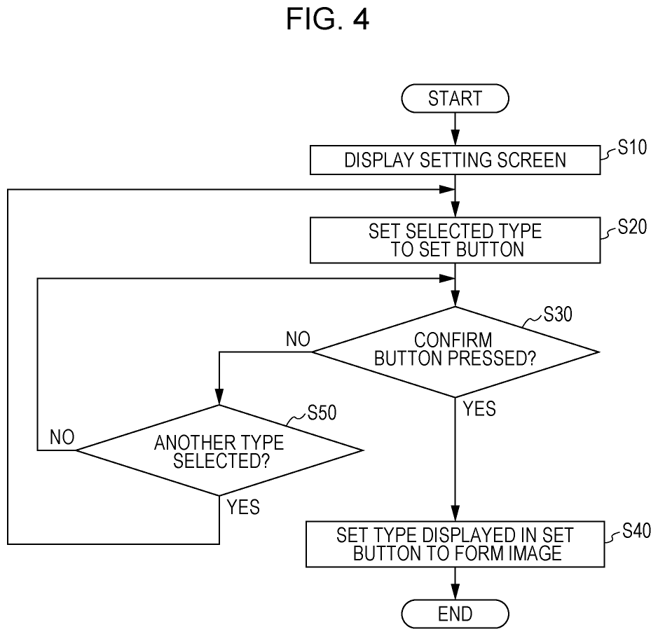

FIG. 4 is a flowchart illustrating the type setting process that the CPU 31 in the information processing apparatus 20 performs when the user selects one of the form images 1 having an unknown type on the confirmation correction screen 2 and presses a compare button 2F. For example, the information processing program defining the type setting process is pre-stored on the ROM 32 in the information processing apparatus 20. The CPU 31 in the information processing apparatus 20 reads the information processing program from the ROM 32 and executes the type setting process.

In step S10, the CPU 31 displays on a display of the client terminal 40 the setting screen 4 that the user uses to set the type to the form image 1 of unknown type.

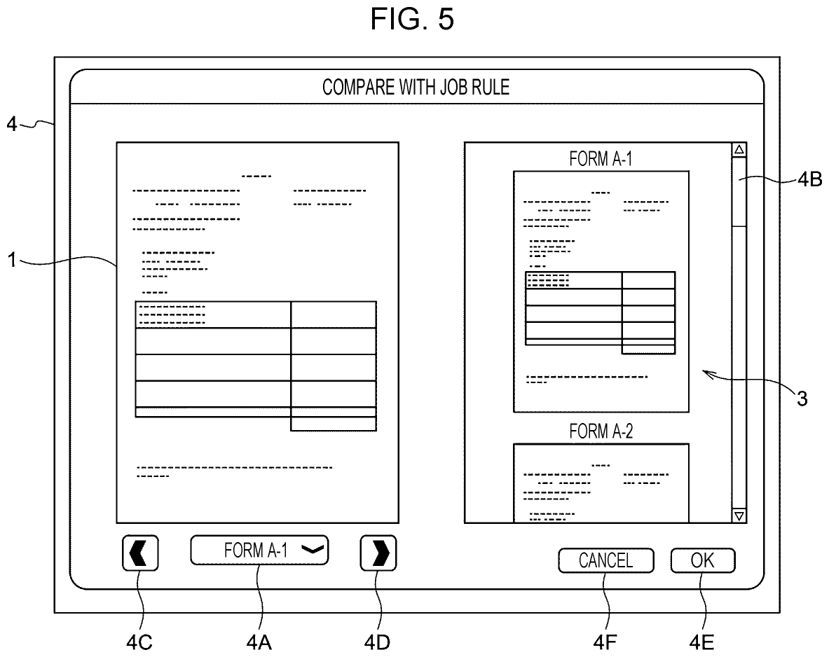

FIG. 5 illustrates an example of the setting screen 4. The setting screen 4 displays the form image 1 of unknown type and multiple registration images 3 defined by the job rule. Since the registration images 3 defined in the job rule are difficult to display on the setting screen 4 at a time in the example of the setting screen 4, the CPU 31 displays the scroll bar 4B such that the user views the registration images 3 on the setting screen 4 by using the scroll bar 4B.

No restrictions are imposed on the display form in which multiple registration images 3 are displayed on the setting screen 4. The CPU 31 may display the registration image 3 in thumbnail view to display all the registration images 3 at a time on the setting screen 4. If the registration images 3 are displayed in thumbnail view, the contents of the registration images 3 may be difficult to view. The CPU 31 may thus display in enlarged view the thumbnail of a registration image 3 specified by the user. Naturally, if the user provides an enlargement instruction for a registration image 3 that is displayed on the setting screen 4 as illustrated in FIG. 5 but is not displayed in thumbnail view, the CPU 31 may display in enlarged view the registration image 3 specified by the user.

If the form image 1 is displayed in the same size as the registration image 3 and the user performs a drag operation on the form image 1, the CPU 31 may display the form image 1 in transparent view such that an image being behind and overlapping the moving form image 1 is transparently viewed. If the form image 1 and registration image 3 are of the same type of form, the locations of the frames and the like in the form image 1 and registration image 3 match each other. The user may verify similarity between the form image 1 and the registration image 3 from the results of overlapping the form image 1 on the registration image 3 and may thus set the type of the form image 1.

The CPU 31 may digitize the similarity between the form image 1 and each of the registration images 3 displayed on the setting screen 4 and display the digitized similarity on the setting screen 4. The similarity is calculated in the form determination in the data reading operation (3) in FIG. 1.

The CPU 31 displays on the setting screen 4 the form image 1 serving as a type setting target, multiple registration images 3, set button 4A, search buttons 4C and 4D, OK button 4E, and cancel button 4F.

The set button 4A is an example of a setting control used to set a type to the form image 1 displayed on the setting screen 4. When the user presses the set button 4A, the CPU 31 displays a dropdown list listing the type of each registration image 3 that has been used to perform the form determination in the data reading operation (3) in FIG. 1.

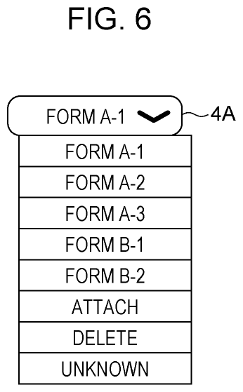

FIG. 6 illustrates an example of the dropdown list displayed when the user presses the set button 4A.

“Form A-1,” “form A-2,” “form A-3,” “form B-1,” and “form B-2” in the dropdown list are character strings representing the types of the registration images 3 defined in the job rule.

The user compares the form image 1 with each of the registration images 3 displayed on the setting screen 4 and selects from the dropdown list on the set button 4A the character string considered to be the type of the form image 1 displayed on the setting screen 4.

The word “attach” in the dropdown list of the set button 4A means that the form image 1 is not the image of a form, such as the registration image 3, but an image of a document that is an identity verification document, such as a license or passport, attached to a form. If the form image 1 is the image of an attached document, the user selects “attach” from the dropdown list of the set button 4A. In this way, the CPU 31 performs the record sorting disregarding the form image 1 with “attach” set.

The word “delete” in the dropdown list of the set button 4A is used to delete the image of a document unrelated to form. The CPU 31 performs the record sorting after deleting the form image 1 with “delete” set from the job.

The word “unknown” in the dropdown list of the set button 4A simply indicates that the form image 1 is an unknown type and is not selectable by the user.

If the type of the form image 1 is selected from the dropdown list of the set button 4A, the CPU 31 stops displaying the dropdown list of the set button 4A in step S20 in FIG. 4 and associates the type selected from the dropdown list with the set button 4A. For example, if the user selects the type “form A-1” from the dropdown list, “form A-1” is displayed on the set button 4A as illustrated in FIG. 5. Specifically, the type associated with the set button 4A is displayed on the set button 4A.

The user presses the OK button 4E to determine that the type of the form image 1 is the selected type.

In step S30, the CPU 31 determines whether the user has pressed the OK button 4E. If the user has pressed the OK button 4E, processing proceeds to step S40.

In step S40, the CPU 31 sets the type selected by the user, namely, the type associated with the set button 4A in the form image 1 as the type of the form image 1 that has been determined to have unknown type.

If the CPU 31 determines in step S30 that the user has not processed the OK button 4E, processing proceeds to step S50.

The user may change the selected type at any time. In step S50, the CPU 31 determines by pressing the set button 4A again whether the user has selected a new type different from the heretofore selected type from the dropdown list of the set button 4A.

If the user has not selected the new type, processing returns to step S30. The CPU 31 continuously monitors whether the OK button 4E is pressed by the user.

On the other hand, if the new type has been selected by the user, processing returns to step S20. In this way, the type newly selected by the user is associated with the set button 4A and is thus displayed on the set button 4A. If the user presses the OK button 4E under this condition, the CPU 31 sets the new type associated with the set button 4A in the form image 1 as the type of the form image 1 that has been determined as having an unknown type.

The type setting process in FIG. 4 is thus complete. If the cancel button 4F is pressed by the user, the CPU 31 displays the confirmation correction screen 2 by closing the setting screen 4 without setting the type to the form image 1.

The user selects the type of the form image 1 from the dropdown list of the set button 4A as described above. The user may select the type of the form image 1 by selecting the registration image 3. Specifically, the CPU 31 may associate the type identical to the type of the registration image 3 selected by the user with the set button 4A. In such a case, the user is free from selecting the type of the form image 1 from the dropdown list by pressing the set button 4A. By simply selecting the registration image 3 displayed on the setting screen 4, the selected type of the registration image 3 is associated with the set button 4A.

To select the registration image 3, the user may press the registration image 3 with a mouse or the like. However, any method may be used as long as it identifies which registration image 3 the user has selected.

As in the setting screen 4 in FIG. 5, the CPU 31 successively scrolls and displays the registration images 3 on the setting screen 4 in response to the operation of the scroll bar 4B by the user. The CPU 31 may regard the registration image 3 displayed on the setting screen 4 as the selected registration image 3. The type of the registration image 3 displayed first is selected as an initial value when the setting screen 4 is displayed. The type of the registration image 3 selected by the user is associated with the set button 4A. When the user scrolls and displays the registration image 3 by operating the scroll bar 4B on the setting screen 4, the type associated with the set button 4A changes in concert with the display of the registration image 3. As a result, the type displayed on the set button 4A changes in concert with the display of the registration image 3. The user may select the type of the form image 1 by simply operating the scroll bar 4B.

Multiple registration images 3 may be displayed on the setting screen 4 by using the scroll operation. The CPU 31 may consider the registration image 3 displayed in a predetermined area, for example, a central region of a scroll display, as the registration image 3 selected by the user.

If the search button 4C is pressed by the user, in the same way as the search button 2C on the confirmation correction screen 2 in FIG. 2 is pressed, the form image 1 of unknown type present before the form image 1 currently being displayed on the setting screen 4 is searched for from among the form images 1 in the job and the found form image 1 of unknown type is displayed on the setting screen 4. If the search button 4D is pressed by the user, in the same way as the search button 2D on the confirmation correction screen 2 in FIG. 2 is pressed, the form image 1 of unknown type present after the form image 1 currently being displayed on the setting screen 4 is searched for from among the form images 1 in the job and the found form image 1 of unknown type is displayed on the setting screen 4.

The search buttons 4C and 4D are examples of a selection control used by the user to select the form image 1. The user may successively select and display the form images 1 of unknown type on the setting screen 4 by simply performing only operations on the setting screen 4 without switching to the confirmation correction screen 2.

The operations performed when the user presses the search button 4C or 4D are described for exemplary purposes only. Even when the form image 1 has the type set therefor, that type may not necessarily be correct. If the user presses the search button 4C or 4D, the CPU 31 may select and display on the setting screen 4 the form image 1 having the page number 2N immediately prior to or subsequent to the page number 2N of the form image 1 currently being displayed on the setting screen 4.

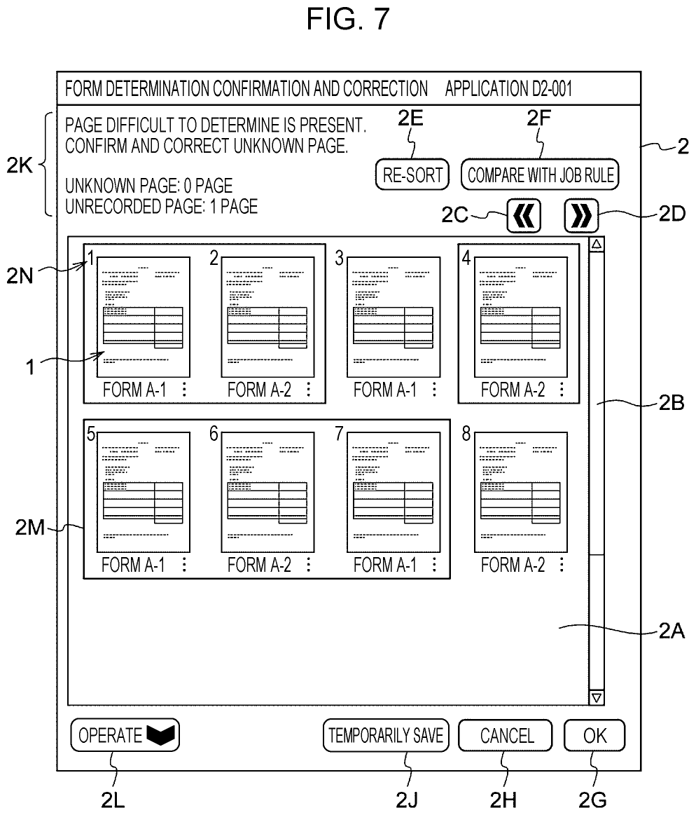

FIG. 7 illustrates an example of the confirmation correction screen 2. The confirmation correction screen 2 results after the type setting process in FIG. 4 is performed on the form image 1 of unknown type in FIG. 2 (the form image 1 with the page number 2N being three) and the type of “form A-1” is set to the form image 1 on the setting screen 4.

Now that the type is set to the form image 1 of unknown type, the information region 2K indicates that the number of unknown pages is zero as illustrated in FIG. 7.

Via the above process, the type of “form A-1” is set to the form image 1 with the page number 2N being three, but record resorting is not yet performed. The user thus presses the re-sort button 2E on the confirmation correction screen 2 and re-sorts the form images 1 included in the job according to the record unit.

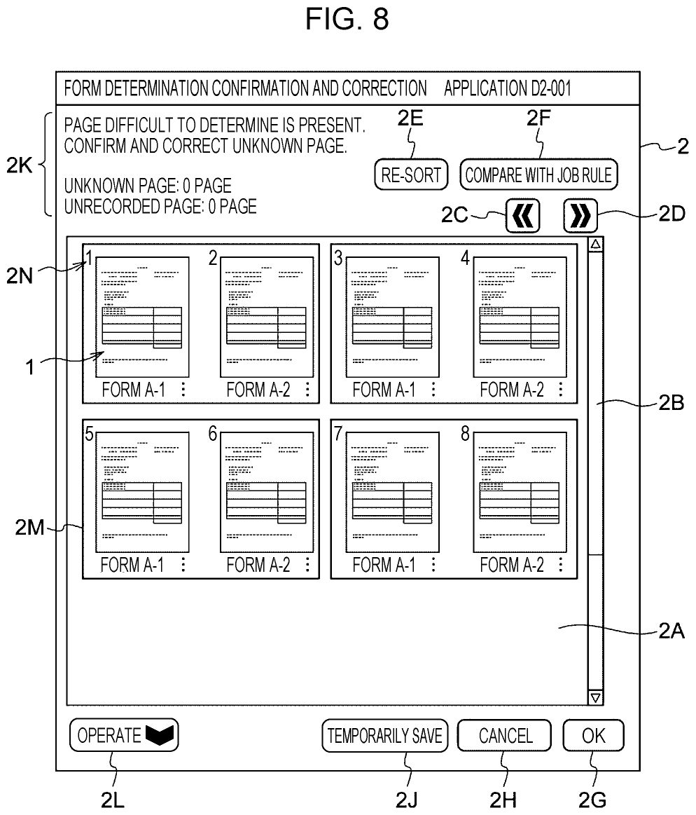

FIG. 8 illustrates an example of the confirmation correction screen 2 after the user presses the re-sort button 2E on the confirmation correction screen 2 in FIG. 7.

In the confirmation correction screen 2 in FIG. 8, the form image 1 on page 3 with the type set to “form A-1” and the form image 1 on page 4 are sorted into a single record. The information region 2K thus indicates that the pages that have not yet been sorted into records are zero.

The CPU 31 may disable an OK button 2G such that the user is unable to press the OK button 2G until types are set to all the form images 1 and the record sorting is complete.

The exemplary embodiment of the information processing apparatus 20 has been described for exemplary purposes only. The exemplary embodiment of the information processing apparatus 20 is not limited to what has been described herein. A variety of changes and modifications are possible in the exemplary embodiment as long as they remains in the scope of the disclosure. Such changes and modifications may fall within the technical scope of the disclosure. For example, the order of operations in the type setting process in FIG. 4 may be changed without departing from the scope of the disclosure.

According to the exemplary embodiment, the type setting process is implemented using software. The process described in the flowchart in FIG. 4 may be implemented using hardware. If the process is described using hardware, the speed of the process may be higher than when the type setting process is implemented using software.

In the exemplary embodiment above, the term “processor” refers to hardware in a broad sense. Examples of the processor include general processors (e.g., the CPU 31) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiments above, and may be changed.

According to the exemplary embodiment, the information processing program is stored on the ROM 32. The storage destination of the information processing program is not limited to the ROM 32. The information processing program of the exemplary embodiment may be distributed in a recorded form that is readable by the computer 30. For example, the information processing program may be provided in a recorded form on an optical disk, such as a compact-disc read-only memory (CD-ROM) or digital versatile disc ROM (DVD-ROM). The information processing program may be distributed in a recorded form on a portable semiconductor memory, such as a universal serial bus (USB) memory or a memory card. The ROM 32, non-volatile memory 34, CD-ROM, DVD-ROM, USB memory, and memory card are examples of non-transitory memory medium.

The information processing apparatus 20 may download via the communication unit 37 the information processing program from an external apparatus connected to the communication network and store the downloaded information processing program on the non-volatile memory 34. The CPU 31 reads the information processing program downloaded from the external apparatus and performs the type setting process.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
display on a screen a form image serving as a target that a form type is to be set to, a plurality of registration images, each registration image pre-registered on a per form type basis, and a setting control used to set a form type to the form image; and
set to the form image a form type that a user having referenced the registration images associates the setting control with.

2. The information processing apparatus according to claim 1, wherein the processor is configured to associate the setting control with a form type represented by a registration image selected by the user from among the registration images.

3. The information processing apparatus according to claim 2, wherein the processor is configured to successively scroll and display the registration images on the screen in response to an instruction from the user and associate the setting control with a form type represented by a registration image displayed on the screen.

4. The information processing apparatus according to claim 1, wherein the processor is configured to:
display on the screen a selection control that the user uses to select a form image; and
if a plurality of form images are present, display on the screen the form image that has been selected by the selection control used by the user.

5. The information processing apparatus according to claim 2, wherein the processor is configured to:
display on the screen a selection control that the user uses to select a form image; and
if a plurality of form images are present, display on the screen the form image that has been selected by the selection control used by the user.

6. The information processing apparatus according to claim 3, wherein the processor is configured to:
display on the screen a selection control that the user uses to select a form image; and
if a plurality of form images are present, display on the screen the form image that has been selected by the selection control used by the user.

7. The information processing apparatus according to claim 4, wherein the processor is configured to display from among the form images a form image with no form type set.

8. The information processing apparatus according to claim 5, wherein the processor is configured to display from among the form images the form image with no form type set.

9. The information processing apparatus according to claim 6, wherein the processor is configured to display from among the form images the form image with no form type set.

10. A non-transitory computer readable medium storing a program causing a computer to execute a process for processing information, the process comprising:
displaying on a screen a form image serving as a target that a form type is to be set to, a plurality of registration images, each registration image pre-registered on a per form type basis, and a setting control used to set a form type to the form image; and
setting on the form image a form type that a user having referenced the registration images associates the setting control with.

11. An information processing apparatus comprising:
means for displaying on a screen a form image serving as a target that a form type is to be set to, a plurality of registration images, each registration image pre-registered on a per form type basis, and a setting control used to set a form type to the form image; and
means for setting on the form image a form type that a user having referenced the registration images associates the setting control with.
